(19) United States
(12) Patent Application Publication
(10) Pub. No.: US 2023/0230762 A1
(43) Pub. Date: Jul. 20, 2023

(54) HIGH FREQUENCY MEDIUM VOLTAGE TRANSFORMER WITH CENTRAL INSULATING DIVIDER

(71) Applicants: Bryce Leonard Hesterman, Providence, UT (US); Dorai Babu Yelaverthi, Raleigh, NC (US)

(72) Inventors: Bryce Leonard Hesterman, Providence, UT (US); Dorai Babu Yelaverthi, Raleigh, NC (US)

(73) Assignee: Utah State University, Logan, UT (US)

(21) Appl. No.: 18/097,183

(22) Filed: Jan. 13, 2023

Related U.S. Application Data
(60) Provisional application No. 63/299,687, filed on Jan. 14, 2022.

(51) Int. Cl. H01F 27/32; H01F 27/30; H01F 27/26

(52) U.S. Cl. CPC H01F 27/324; H01F 27/306; H01F 27/263; H01F 2038/003

(57) ABSTRACT

An apparatus for a transformer with an insulating divider includes a primary winding proximate to a primary magnetic core assembly and a secondary winding proximate to a secondary magnetic core assembly. The primary magnetic core assembly and the secondary magnetic core assembly are made of materials with a high magnetic permeability. The apparatus includes a divider placed between the primary and secondary magnetic core assemblies. The divider includes an electrically insulating material. The apparatus includes an electrically insulating potting material surrounding each of the magnetic core assemblies in a vicinity of the divider.

### CROSS-REFERENCES TO RELATED APPLICATIONS

This application claims the benefit of U.S. Provisional Patent Application No. 63/299,687 entitled “High Frequency Medium Voltage Transformer with Central Insulating Divider” and filed on Jan. 14, 2022 for Bryce Leonard Hesterman, et al., which is incorporated herein by reference.

### GOVERNMENT LICENSE RIGHTS

This invention was made with government support under grant #202243 awarded by the Department of Energy. The government has certain rights in the invention.

### FIELD

This invention relates to transformers and more particularly relates to high frequency medium voltage transformers with a central insulating divider.

### BACKGROUND

Transformers are often used to pull relatively high voltages from power grids and convert them to lower voltages for commercial and everyday household use. Transformers include two or more coils that are wound around on a core of material that has a high magnetic permeability capable of carrying magnetic flux. Primary windings of transformers are typically connected to some source of alternating current (“AC”) voltage. Secondary windings of transformers often produce voltages that are mostly related to the ratio between the number of turns in the primary and secondary windings. The turns ratio allows transformers to be designed to produce output voltages across the secondary windings that are the same, higher, or lower than the input voltages applied to primary windings by adjusting the turns ratio.

Transformers that are intended to operate at high frequencies commonly use cores that are made of a ferrite ceramic material instead of cores made from metals because ferrite cores typically have much lower losses than metallic cores at high frequencies. Power that can be efficiently transferred through a transformer typically depends on the size of the core and on the amount of conductive material such as copper or aluminum used in the windings. Ferrite cores, however, are often limited in size to be only up to about 10 centimeters in any dimension. Consequently, high frequency transformers that need to transfer many kilowatts of power commonly use several ferrite cores that are assembled to form a larger core structure.

Large transformer cores are often assembled from several pieces of U-shaped ferrite core pieces. When very high input voltages are used in a power converter, it is common to connect several converter input sections in series, while the output sections are connected in parallel to obtain a lower output voltage. High-power switching power converters that process power from the AC grid are often referred to as solid-state transformers. It is challenging to design transformers that are suited for use in solid state transformers because the voltage between the primary and secondary windings can be thousands of volts.

### SUMMARY

An apparatus for a transformer with an insulating divider includes a primary winding proximate to a primary magnetic core assembly and a secondary winding proximate to a secondary magnetic core assembly. The primary magnetic core assembly and the secondary magnetic core assembly are made of materials with a high magnetic permeability. The apparatus includes a divider placed between the primary and secondary magnetic core assemblies. The divider includes an electrically insulating material. The apparatus includes an electrically insulating potting material surrounding each of the magnetic core assemblies in a vicinity of the divider.

A converter with a transformer with an insulating divider includes a primary circuit with a primary winding where the primary circuit includes input terminals. The converter includes a secondary circuit with a secondary winding where the secondary circuit includes output terminals. The converter includes a transformer with a primary magnetic core assembly proximate to the primary winding and a secondary magnetic core assembly proximate to the secondary winding. The primary magnetic core assembly and the secondary magnetic core assembly include of materials with a high magnetic permeability. The transformer includes a divider placed between the primary and secondary magnetic core assemblies and the divider includes an electrically insulating material. The transformer includes an electrically insulating potting material surrounding each of the magnetic core assemblies in a vicinity of the divider.

A transformer with an insulating divider includes a primary winding proximate to a primary magnetic core assembly and a secondary winding proximate to a secondary magnetic core assembly. The primary magnetic core assembly and the secondary magnetic core assembly include materials with a high magnetic permeability. The transformer includes a divider placed between the primary and secondary magnetic core assemblies where the divider includes an electrically insulating material. The transformer includes an electrically insulating potting material surrounding each of the magnetic core assemblies in a vicinity of the divider. The primary magnetic core assembly and the secondary magnetic core assembly each include a field-spreading plate positioned adjacent to the divider. Each field-spreading plate includes an area adjacent to the divider that is greater than an area of a cross section of the magnetic core assembly adjacent to the field-spreading plate. The primary magnetic core assembly and the secondary magnetic core assembly each have at least one core section. Each core section includes at least two extension sections positioned in parallel and connected by at least one connection section. Each extension section has a first end distal to the connection section where the first end of each core section is adjacent to a field-spreading plate in contact with the divider. The at least one core section and field-spreading plates of the primary magnetic core assembly are in electrical connection with each other and the at least one core sections and field-spreading plates of the secondary magnetic core assembly are in electrical contact with each other.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a schematic block diagram illustrating a converter with a transformer that includes an insulating divider and field-spreading plates, according to various embodiments;

FIG. 1B is an enlarged side section view illustrating a portion of the transformer of FIG. 1A that includes an insulating divider and without a field-spreading plate, according to various embodiments;

FIG. 1C is an enlarged side section view illustrating a portion of the transformer of FIG. 1A that includes an insulating divider and with field-spreading plates, according to various embodiments;

FIG. 1D is an enlarged perspective view illustrating a portion of the transformer of FIG. 1A that includes an insulating divider and field-spreading plates, according to various embodiments;

FIG. 1E is a section view illustrating a section of the portion of the transformer of FIG. 1A that includes an insulating divider and with a field-spreading plate, according to various embodiments;

FIG. 2A is a perspective view illustrating an E-core transformer with an insulating divider and field-spreading plates, according to various embodiments;

FIG. 2B an exploded perspective view of the E-core transformer of FIG. 2A;

FIG. 3A is a perspective view illustrating a transformer with U-shaped magnetic core assemblies and with an insulating divider and field-spreading plates, according to various embodiments;

FIG. 3B is an exploded perspective view of the transformer of FIG. 3A, according to various embodiments;

FIG. 3C is an enlarged perspective view of a portion of the transformer of FIG. 3A depicting a portion of a field-spreading plate in a field-spreading plate positioner, according to various embodiments; and

FIG. 4 is a representation of a simulation of electric field strength between two halves of the transformer of FIG. 3A (a) before potting and (b) after potting, according to various embodiments.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more embodiments. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

An apparatus for a transformer with an insulating divider includes a primary winding proximate to a primary magnetic core assembly and a secondary winding proximate to a secondary magnetic core assembly. The primary magnetic core assembly and the secondary magnetic core assembly are made of materials with a high magnetic permeability. The apparatus includes a divider placed between the primary and secondary magnetic core assemblies. The divider includes an electrically insulating material. The apparatus includes an electrically insulating potting material surrounding each of the magnetic core assemblies in a vicinity of the divider.

In some embodiments, the primary magnetic core assembly and the secondary magnetic core assembly each include a field-spreading plate positioned adjacent to the divider. Each field-spreading plate has an area adjacent to the divider that is greater than an area of a cross section of the magnetic core assembly adjacent to the field-spreading plate. In other embodiments, the primary magnetic core assembly and the secondary magnetic core assembly each have at least one core section. Each core section includes at least two extension sections positioned in parallel and connected by at least one connection section. Each extension section includes a first end distal to the connection section where the first end of each core section is adjacent to a field-spreading plate in contact with the divider. In other embodiments, the at least one core section and field-spreading plates of the primary magnetic core assembly are in electrical connection with each other and the at least one core sections and field-spreading plates of the secondary magnetic core assembly are in electrical connection with each other. In other embodiments, the primary winding is wound around the extension sections of the primary magnetic core assembly together in a center section and the secondary winding is wound around the extension sections of the secondary magnetic core assembly together in a center section.

In other embodiments, the apparatus includes, for each of the primary magnetic core assembly and the secondary magnetic core assembly, a field-spreading plate positioner. Each field-spreading plate positioner is shaped to hold each field-spreading plate in a position adjacent to the divider prior to placement of the electrically insulating potting material where an opening for each field-spreading plate is sized to accommodate the electrically insulating potting material. In other embodiments, the opening for each field-spreading plate includes extensions positioned towards a location of the field-spreading plate positioned in the opening. The extensions are configured to hold the field-spreading plate positioned in the opening a specified distance from edges of the opening. In other embodiments, the apparatus includes a primary bobbin shaped to provide spacing between turns of the primary winding and a secondary bobbin shaped to provide spacing between turns of the secondary winding.

In some embodiments, edges of the field-spreading plates are rounded and the electrically insulating potting material is positioned at least in gaps around the edges of the field-spreading plates. In other embodiments, the electrically insulating potting material is substantially free of voids. In other embodiments, the materials with the high magnetic permeability of the primary magnetic core assembly and the secondary magnetic core assembly include a ferrite. In other embodiments, a thickness of the divider in a direction between the primary magnetic core assembly and the secondary magnetic core assembly is sized to a breakdown voltage rating. In other embodiments, a connection of a primary circuit is electrically connected to the primary magnetic core assembly where the primary circuit is connected to the primary winding wound around the primary magnetic core assembly, and a connection of a secondary circuit is electrically connected to the secondary magnetic core assembly and the secondary circuit is connected to the secondary winding wound around the secondary magnetic core assembly.

A converter with a transformer with an insulating divider includes a primary circuit with a primary winding where the primary circuit includes input terminals. The converter includes a secondary circuit with a secondary winding where the secondary circuit includes output terminals. The converter includes a transformer with a primary magnetic core assembly proximate to the primary winding and a secondary magnetic core assembly proximate to the secondary winding. The primary magnetic core assembly and the secondary magnetic core assembly include of materials with a high magnetic permeability. The transformer includes a divider placed between the primary and secondary magnetic core assemblies and the divider includes an electrically insulating material. The transformer includes an electrically insulating potting material surrounding each of the magnetic core assemblies in a vicinity of the divider.

In some embodiments, the primary magnetic core assembly and the secondary magnetic core assembly each include a field-spreading plate positioned adjacent to the divider. Each field-spreading plate includes an area adjacent to the divider that is greater than an area of a cross section of the magnetic core assembly adjacent to the field-spreading plate. In other embodiments, the primary magnetic core assembly and the secondary magnetic core assembly each include at least one core section. Each core section includes at least two extension sections positioned in parallel and connected by at least one connection section. Each extension section includes a first end distal to the connection section where the first end of each core section is adjacent to a field-spreading plate in contact with the divider.

In some embodiments, the converter includes, for each of the primary magnetic core assembly and the secondary magnetic core assembly, a field-spreading plate positioner. Each field-spreading plate positioner is shaped to hold each field-spreading plate in a position adjacent to the divider prior to placement of the electrically insulating potting material. An opening for each field-spreading plate is sized to accommodate the electrically insulating potting material. In other embodiments, the opening for each field-spreading plate includes extensions positioned towards a location of the field-spreading plate positioned in the opening. The extensions are configured to hold the field-spreading plate positioned in the opening a specified distance from edges of the opening.

A transformer with an insulating divider includes a primary winding proximate to a primary magnetic core assembly and a secondary winding proximate to a secondary magnetic core assembly. The primary magnetic core assembly and the secondary magnetic core assembly include materials with a high magnetic permeability. The transformer includes a divider placed between the primary and secondary magnetic core assemblies where the divider includes an electrically insulating material. The transformer includes an electrically insulating potting material surrounding each of the magnetic core assemblies in a vicinity of the divider. The primary magnetic core assembly and the secondary magnetic core assembly each include a field-spreading plate positioned adjacent to the divider. Each field-spreading plate includes an area adjacent to the divider that is greater than an area of a cross section of the magnetic core assembly adjacent to the field-spreading plate. The primary magnetic core assembly and the secondary magnetic core assembly each have at least one core section. Each core section includes at least two extension sections positioned in parallel and connected by at least one connection section. Each extension section has a first end distal to the connection section where the first end of each core section is adjacent to a field-spreading plate in contact with the divider. The at least one core section and field-spreading plates of the primary magnetic core assembly are in electrical connection with each other and the at least one core sections and field-spreading plates of the secondary magnetic core assembly are in electrical contact with each other.

In some embodiments, the transformer includes, for each of the primary magnetic core assembly and the secondary magnetic core assembly, a field-spreading plate positioner. Each field-spreading plate positioner is shaped to hold each field-spreading plate in a position adjacent to the divider prior to placement of the electrically insulating potting material. An opening for each field-spreading plate is sized to accommodate the electrically insulating potting material. The opening for each field-spreading plate includes extensions positioned towards a location of the field-spreading plate positioned in the opening. The extensions are configured to hold the field-spreading plate positioned in the opening a specified distance from edges of the opening.

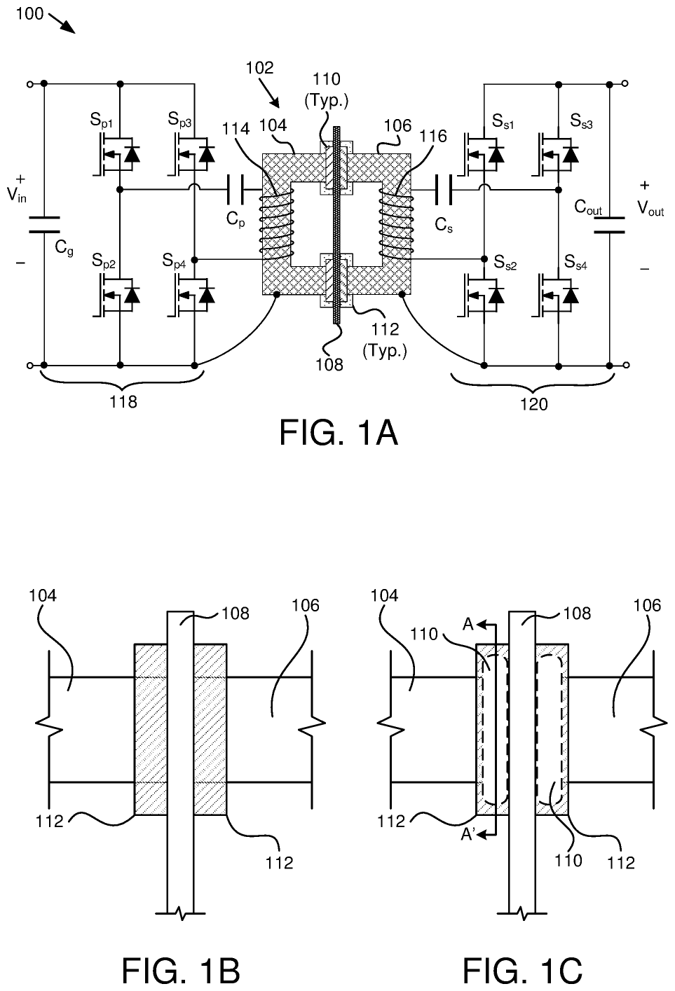

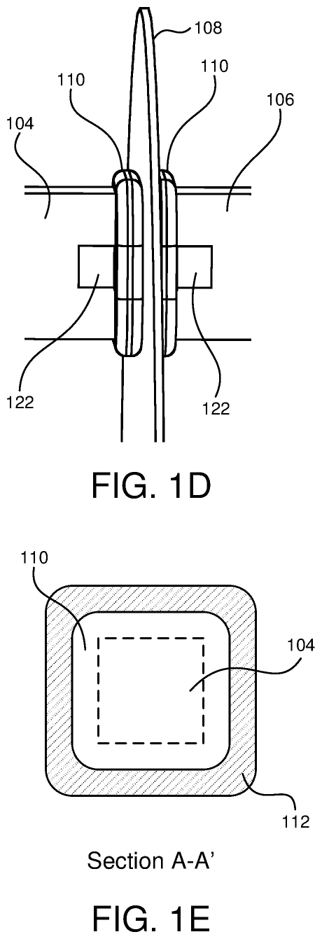

It is challenging to design transformers that are suited for use in solid state transformers because the voltage between the primary and secondary windings can be thousands of volts. One way to achieve the isolation is to put an insulating material between the primary and secondary halves of a transformer. A novel insulation concept is proposed that achieves high voltage insulation without complicating the fabrication or cooling requirements for the transformer. The idea is to confine high electric fields present in high voltage transformers to a small region. Then only this small region is potted with a high dielectric strength material. This design is achieved by segregating the primary and secondary side of the transformer on either side of an insulation divider, as depicted in FIG. 1A.

FIG. 1A is a schematic block diagram illustrating a converter 100 with a transformer 102 that includes an insulating divider 108 and field-spreading plates 110, according to various embodiments. The converter 100 depicted in FIG. 1A is in a dual active bridge (“DAB”) configuration, which is one possible converter design where the transformer 102 with an insulating divider 108 may be utilized. The primary circuit 118 and the secondary circuit 120 each include an H-bridge, each with four switches controlled to produce square waves. Phase shift between the square waves is used for control. The resultant topology, in some embodiments, is referred to as a phase-shift controlled capacitor-inductor-inductor-inductor-capacitor (“CLLLC”) dual active bridge.

The transformer 102 includes a primary winding 114 proximate to a primary magnetic core assembly 104 and a secondary winding 116 proximate to a secondary magnetic core assembly 106. Typically, the windings 114, 116 are wrapped around a portion of the magnetic core assemblies 104, 106. The primary magnetic core assembly 104 and the secondary magnetic core assembly 106, in some embodiments, include materials with a high magnetic permeability. A divider 108 placed between the primary and secondary magnetic core assemblies 104, 106 and the divider 108 includes an electrically insulating material. In some embodiments, the dielectric strength of the divider 108 is 20 kilovolts (“kV”) or other convenient rating. In some embodiments, the divider is sized to provide creepage and clearance between primary and secondary windings 114, 116 as recommended in Underwriter Laboratories (“UL”) standard 2877.

An electrically insulating potting material 112 surrounds each of the magnetic core assemblies 104, 106 in a vicinity of the divider 108. In some embodiments, the primary magnetic core assembly 104 and the secondary magnetic core assembly 106 each include a field-spreading plate 110 positioned adjacent to the divider 108. Each field-spreading plate 110 has an area adjacent to the divider 108 that is greater than an area of a cross section of the magnetic core assembly 104, 106 adjacent to the field-spreading plate 110. In some embodiments, the potting material 112 surrounds the field-spreading plate 110 and may also surround a portion of the corresponding magnetic core assembly 104, 106.

The inductances of the primary and secondary windings 114, 116 are low due to the airgap introduced by the insulating divider 108. The reduced magnetizing inductance Lₘ helps in introducing a reactive current that enables zero voltage switching (“ZVS”) even at no-load operation. In some embodiments, the reactive current may be excessive and so it may be desirable to increase the primary and secondary inductances. These inductances are inversely related to the thickness the divider 108 which separates the primary magnetic core assembly 104 and the secondary magnetic core assembly 106, but in contrast, those inductances are directly related to the area of the field-spreading plates 110 adjacent to the divider 108. Thus, excessively low winding inductances can be compensated for by adding the field spreaders 110.

In the converter 100, in some embodiments, leakage inductance energy in the transformer 102 is high due to segregation of windings on opposite sides of the divider 108. A leakage inductance between the primary and secondary windings 114, 116, in some embodiments, is used as the inductive element of a resonant tank. The series resonant capacitors, Cₚ and Cₛ, partly compensate for the high leakage inductance and help reduce harmonics by shaping the series tank currents to be sinusoidal. These capacitors, Cₚ and Cₛ, also help eliminate any steady-state direct current (“DC”) current in the transformer windings.

Thickness of the insulation of the divider 108 is selected to withstand a required breakdown voltage rating, which is based on voltages of the primary and secondary of the transformer 102. The magnetic core assemblies 104, 106 on each half, in some embodiments, is tied to the negative rail of that particular H-bridge. A peak potential between the magnetic core assemblies (e.g., 104) and its winding (e.g., 114) is just a rated voltage of a low voltage (“LV”) module where the transformer 102 is used. High dielectric stress, in some embodiments, is mainly experienced in the region around where the two magnetic core assemblies 104, 106 are close. (See FIG. 4.) To avoid partial discharge in air (e.g., corona) around this region, in some embodiments, potting material 112 is included to replace air with a much higher dielectric strength material. In embodiments described herein, the windings 114, 116 and most of the ferrite volume need not be potted. This significantly simplifies the fabrication process since only small regions are potted 112. The thermal conductivity to ambient can also be maintained high with this approach. The proposed insulation concept can be used in conventional input series output parallel (“ISOP”) multi-module solid-state transformer (“SST”) converters as well as other converters.

In some embodiments, a connection of a primary circuit 118 is electrically connected to the primary magnetic core assembly 104 and the primary circuit 118 is connected to the primary winding 114 wound around the primary magnetic core assembly 104. In some embodiments, a connection of a secondary circuit 120 is electrically connected to the secondary magnetic core assembly 106 and the secondary circuit 120 is connected to the secondary winding 116 is wound around the secondary magnetic core assembly 106. In some embodiments, the connection to the primary circuit 118 is at a negative side of the primary circuit 118 and/or the connection to the secondary circuit 120 is at a negative side of the secondary circuit 120.

FIG. 1B is an enlarged side section view illustrating a portion of the transformer 102 of FIG. 1A that includes an insulating divider 108 and without a field-spreading plate 110, according to various embodiments. The interface between the primary magnetic core assembly 104 and the divider 108 includes insulating potting material 112 and the interface between the secondary magnetic core assembly 106 and the divider 108 also includes insulating potting material 112. The insulating potting material 112 is placed where the electrical field strength is highest to prevent corona along edges of the magnetic core assemblies 104, 106. The transformer 102 may be constructed with or without a field-spreading plate 110.

FIG. 1C is an enlarged side section view illustrating a portion of the transformer 102 of FIG. 1A that includes an insulating divider 108 and with field-spreading plates 110, according to various embodiments. FIG. 1D is an enlarged perspective view illustrating a portion of the transformer 102 of FIG. 1A that includes an insulating divider 108 and field-spreading plates 110, according to various embodiments. A field-spreading plate 110 is placed between the primary magnetic core assembly 104 and the divider 108 and a field-spreading plate 110 is placed between the secondary magnetic core assembly 106 and the divider 108. In the embodiment of FIG. 1D, a copper tape strip 122 connects the magnetic core assemblies 104, 106 with the field-spreading plates 110 so that the field spreading plates 110 are at the same electric potential as the adjacent parts of magnetic core assemblies 104, 106. In some embodiments, an electrically conductive adhesive could be used instead of the copper tape strip 122.

Each field-spreading plate 110 has an area adjacent to the divider 108 that is greater than an area of a cross section of the magnetic core assembly 104, 106 adjacent to the field-spreading plate 110, which helps to increase the magnetizing inductance and also make the design more tolerant to misalignment of the primary and secondary magnetic core assemblies 104, 106. Typically, electric fields non-linearly distribute across an insulator, intensifying at edges and corners of conductors. In some embodiments, the field-spreading plates 110 include rounded corners to reduce field intensities. Sharp edges are avoided at the interface of the two halves of the transformer 102 to reduce the electrical field intensities by using a rounded edge field-spreading plate 110. However, the fields at the corners of the field-spreading plates, in some embodiments, are high enough for the air around that region to break down and cause the partial discharge (corona), as depicted in FIG. 4. Insulating potting material 112 replaces the air in the location where the electric field intensities are high to prevent corona. When the insulating potting material 112 is sufficiently thick, the electric field intensities in the air outside insulating potting material 112 is low enough that the air will not break down. Corona produces ozone which will degrade typical insulating materials, so eliminating corona can extend the service life of the transformer 102.

FIG. 1E is a section view illustrating a section of the portion of the transformer 102 of FIG. 1A that includes an insulating divider 108 and with a field-spreading plate 110, according to various embodiments. Section A-A′ depicted in FIG. 1E is shown in FIG. 1C. An outline of some embodiments of and end of a primary magnetic core assembly 104 is depicted with dashed lines and a field-spreading plate 110 is depicted with a bigger footprint than the primary magnetic core assembly 104. Potting material 112 surrounds the field-spreading plate 110. The footprint of the field-spreading plate 110 is sized depending on a desired magnetizing inductance, tolerance to misalignment, etc. The amount of potting material 112 surrounding the field-spreading plates 110 is chosen based on electric field strength. In some embodiments, finite element analysis may be used to determine electric field strength to size potting material 112 around the field-spreading plates 110.

The potting material 112, in some embodiments, is a high dielectric strength material. In some embodiments, 3M® Scotchcast® Electrical Resin 280 material, which has a dielectric strength of 14.8 kilovolts (“kV”)/millimeter (“mm”) is used. Other potting materials may also be used. In some embodiments, the potting material 112 is a liquid that is poured into gaps around the edges of the field-spreading plates 110 and solidified during a curing process. In other embodiments the potting material 112 is a melted substance that is injected into the gaps and then solidifies as it is cooled.

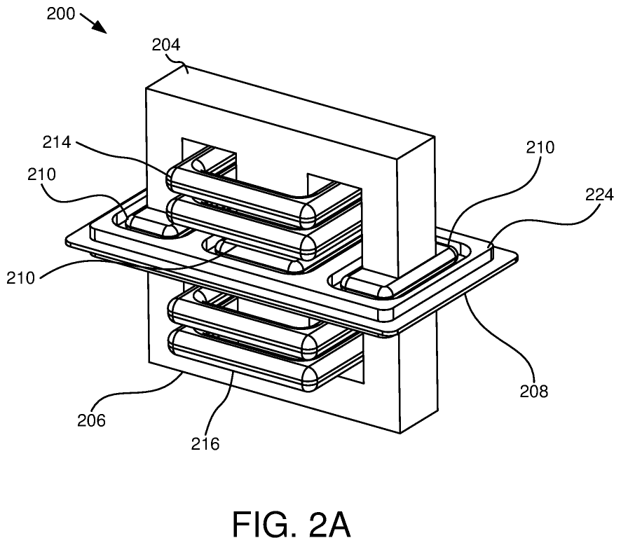

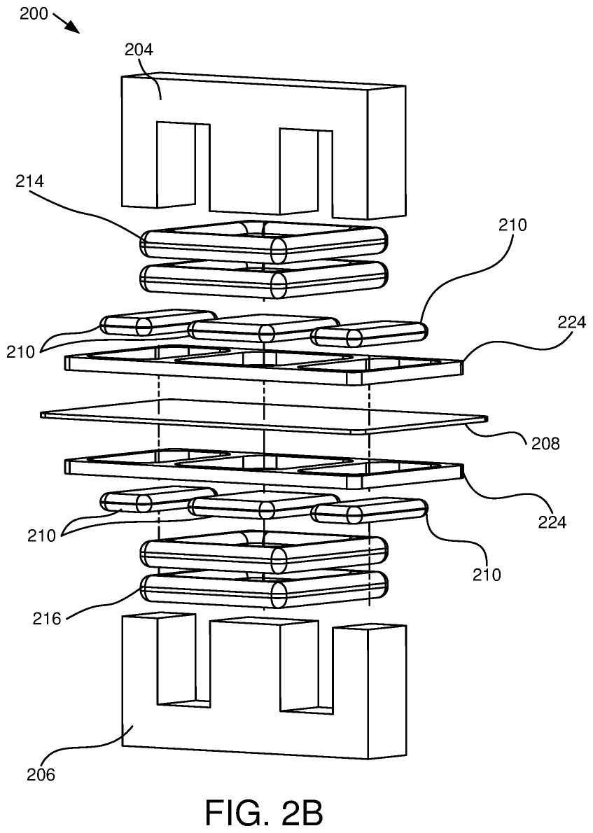

FIG. 2A is a perspective view illustrating an E-core transformer 200 with an insulating divider 208 and field-spreading plates 210, according to various embodiments. FIG. 2B an exploded perspective view of the E-core transformer 200 of FIG. 2A. The E-core transformer 200 of FIGS. 2A and 2B is an example of another transformer design that could be used with a divider 208 and could also be used with field-spreading plates 210. The E-core transformer 200 includes a primary magnetic E-core assembly 204 and a secondary E-core assembly 206 where extension sections are parallel to each other and are connected with a connection section. The E-core transformer 200 includes a divider 208 between the magnetic E-core assemblies 204, 206. In the embodiments depicted in FIGS. 2A and 2B, field-spreading plates 210 are positioned between the magnetic E-core assemblies 204, 206 and the divider 208. A primary winding 214 is positioned to wrap around a center extension section of the primary magnetic E-core assembly 204 and a secondary winding 216 is positioned to wrap around a center extension of the secondary magnetic E-core assembly 206.

The primary and secondary sides of the E-core transformer 200 each include a field-spreading plate positioner 224 that includes an opening for each field-spreading plate 210. In some embodiments, each opening includes extensions (not shown) positioned towards a location of the field-spreading plate 210 positioned in the opening. The extensions are configured to hold the field-spreading plate 210 positioned in the opening a specified distance from edges of the opening. In some examples, the extensions hold the field-spreading plate 210 centered in the opening and the space between the field-spreading plate 210 and the opening is sized for the potting material (not shown).

In some embodiments, the opening extends away from the divider 208 further than a height of the field-spreading plate 210 so that potting material is able to cover a top portion of the field-spreading plate 210 opposite a side adjacent to the divider 208. The field-spreading plate positioner 224 provides a convenient guide for positioning the field-spreading plate 210 and a convenient well for placement of the potting material. In some embodiments, potting is done is a vacuum chamber to minimize or eliminate any air around the field-spreading plate 210 so that the potting material is substantially free of voids.

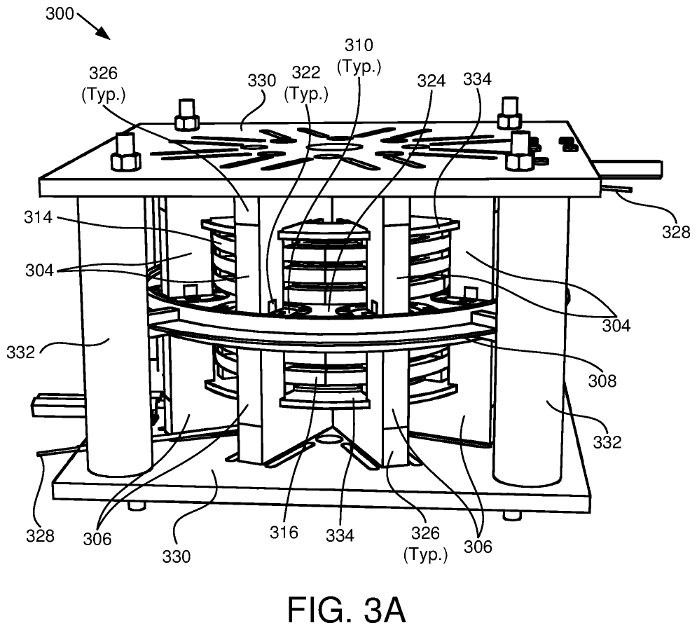

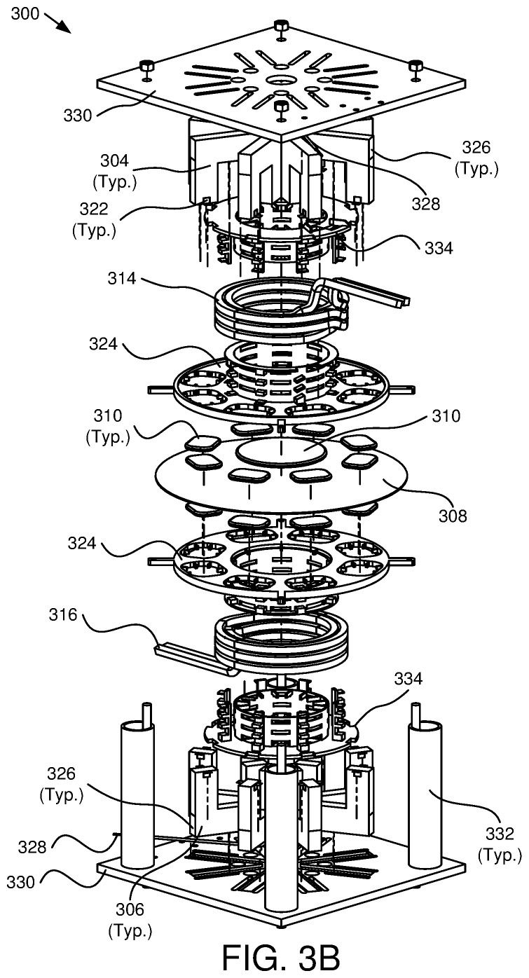

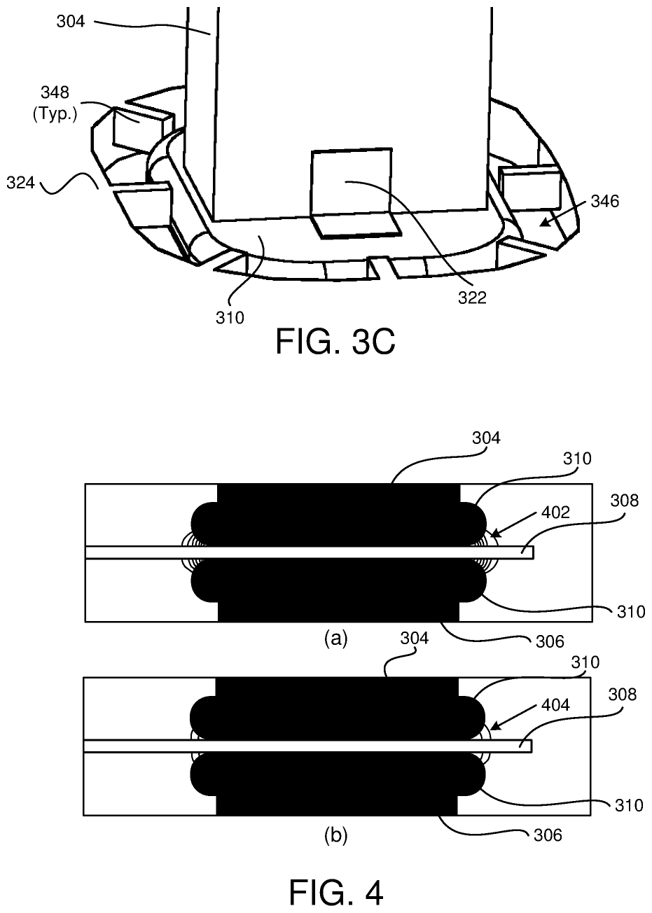

FIG. 3A is a perspective view illustrating a transformer 300 with U-shaped core sections 304, 306 and with an insulating divider 308 and field-spreading plates 310, according to various embodiments. FIG. 3B is an exploded perspective view of the transformer 300 of FIG. 3A, according to various embodiments. The transformer 300 includes primary U-shaped core sections 304 forming a primary magnetic core assembly and secondary U-shaped core sections 306 forming a secondary magnetic core assembly. Each U-shaped core section 304, 306 includes two extension sections positioned in parallel and connected by at least one connection section. Each extension section is depicted as being positioned vertically and the connection section is depicted as being oriented horizontally.

In some embodiments, the primary winding 314 is wound around the extension sections of the primary magnetic core assembly together in a center section and the secondary winding 316 is wound around the extension sections of the secondary magnetic core assembly together in a center section. In some embodiments, each U-shaped core section 304, 306 has an inner extension section surrounded by a winding 314, 316 and in contact with a common field-spreading plate 310, which is the inner, larger field-spreading plate 310 depicted in FIG. 3B.

In some embodiments, the primary U-shaped core sections 304 of the primary magnetic core assembly are electrically connected. In some embodiments, the primary U-shaped core sections 304 of the primary magnetic core assembly each include copper tape 326 that are electrically connected in a center section and include a wire 328 for connection to a primary circuit. Likewise, in some embodiments the secondary U-shaped core sections 306 of the secondary magnetic core assembly are electrically connected. In some embodiments, the secondary U-shaped core sections 306 of the secondary magnetic core assembly each include copper tape 326 that are electrically connected in the center section and include a wire 328 for connection to a secondary circuit.

In some embodiments, each field-spreading plate 310 is positioned in contact with a divider 308 in the shape of a disk. In some embodiments, each extension section is connected to a field-spreading plate 310 with a copper tape strip 322 or similar conductive connector. In some embodiments, each of the U-shaped core sections and the connected field-spreading plates 310 of the primary magnetic core assembly are in electrical connection with each other and each of the U-shaped core sections and the connected field-spreading plates 310 of the secondary magnetic core assembly are in electrical connection with each other.

In some embodiments, the transformer 300 includes, for each of the primary magnetic core assembly and the secondary magnetic core assembly, a field-spreading plate positioner 324. Each field-spreading plate positioner 324 is shaped to hold each field-spreading plate 310 in a position adjacent to the divider 308 prior to placement of the electrically insulating potting material (not shown). In some embodiments, an opening for each field-spreading plate 310 is sized to accommodate the electrically insulating potting material.

In some embodiments, the transformer 300 includes a primary bobbin 334 shaped to provide spacing between turns of the primary winding 314 and a secondary bobbin 334 shaped to provide spacing between turns of the secondary winding 316. In some embodiments, the spacing between turns helps to reduce winding capacitance. In other embodiments, the spacing between turns allows for better heat dissipation by letting forced air to flow through the windings 314, 316 to reach the inner extension sections of the core sections 304, 306. In some embodiments, the bobbins 334 are made of an electrically insulating material, such as nylon. In other embodiments, the material for the bobbins 334 is able to withstand high temperatures during operation. For the transformer 300 of FIGS. 3A and 3B, the bobbins 334 are divided into two parts with one part connected to the field-spreading plate positioner 324 and another part is shown near the U-shaped core sections 304, 306.

In some embodiments, parts of the transformer 300 are held in place with an upper and a lower plate 330 that are bolted together through columns 332. In other embodiments, parts of the transformer 300 are held together with an adhesive, with bolts, with connectors, etc. One of skill in the art will recognize other ways to hold a transformer 300 with a divider 308 between core sections 304, 306.

FIG. 3C is an enlarged perspective view of a portion of the transformer 300 of FIG. 3A depicting a portion of a field-spreading plate 310 in a field-spreading plate positioner 324, according to various embodiments. In some embodiments, the field-spreading plate positioner 324 is shaped to hold each field-spreading plate 310 in a position adjacent to the divider 308 prior to placement of the electrically insulating potting material.

An opening 346 for each field-spreading plate 310 is sized to accommodate the electrically insulating potting material. In some embodiments, the opening 346 for each field-spreading plate 310 includes extensions 348 positioned towards a location of the field-spreading plate 310 positioned in the opening 346 where the extensions 348 are configured to hold the field-spreading plate 310 positioned in the opening 346 a specified distance from edges of the opening 346. In some embodiments, the extensions 348 have an insulation rating the same as or higher than the potting material.

In some embodiments, edges of the field-spreading plates 310 are rounded and the electrically insulating potting material is positioned at least in gaps around the edges of the field-spreading plates 310. FIG. 4 is a representation of a simulation of electric field strength between two halves of the transformer 300 of FIG. 3A (a) before potting and (b) after potting, according to various embodiments. The field-spreading plates 310 are depicted with rounded edges, which causes a gap between the divider 308 and the field-spreading plates 310. Before potting, as depicted in the top simulation (a), the electric field strength is very high in the gaps 402 between the divider 308 and the field-spreading plates 310, which is represented by lines grouped close together. The electrical field strength in the gap 402 may be high enough for a corona discharge.

The bottom simulation (b) depicts the electrical field strength around the field-spreading plate 310 and divider 308 with potting material. The electrical field strength is less in the gaps 404 between the field-spreading plates 310 and divider 308, as depicted by less lines, which reduces the possibility of corona.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a primary winding proximate to a primary magnetic core assembly;
a secondary winding proximate to a secondary magnetic core assembly, the primary magnetic core assembly and the secondary magnetic core assembly comprised of materials with a high magnetic permeability;
a divider placed between the primary and secondary magnetic core assemblies, the divider comprising an electrically insulating material; and
an electrically insulating potting material surrounding each of the magnetic core assemblies in a vicinity of the divider.

2. The apparatus of claim 1, wherein the primary magnetic core assembly and the secondary magnetic core assembly each comprise a field-spreading plate positioned adjacent to the divider, each field-spreading plate comprising an area adjacent to the divider that is greater than an area of a cross section of the magnetic core assembly adjacent to the field-spreading plate.

3. The apparatus of claim 2, wherein the primary magnetic core assembly and the secondary magnetic core assembly each comprise at least one core section, each core section comprising at least two extension sections positioned in parallel and connected by at least one connection section, wherein each extension section comprises a first end distal to the connection section, wherein the first end of each core section is adjacent to a field-spreading plate in contact with the divider.

4. The apparatus of claim 3, wherein the at least one core section and field-spreading plates of the primary magnetic core assembly are in electrical connection with each other and the at least one core sections and field-spreading plates of the secondary magnetic core assembly are in electrical connection with each other.

5. The apparatus of claim 4, wherein the primary winding is wound around the extension sections of the primary magnetic core assembly together in a center section and wherein the secondary winding is wound around the extension sections of the secondary magnetic core assembly together in a center section.

6. The apparatus of claim 2, further comprising, for each of the primary magnetic core assembly and the secondary magnetic core assembly, a field-spreading plate positioner, each field-spreading plate positioner shaped to hold each field-spreading plate in a position adjacent to the divider prior to placement of the electrically insulating potting material, wherein an opening for each field-spreading plate is sized to accommodate the electrically insulating potting material.

7. The apparatus of claim 6, wherein the opening for each field-spreading plate comprises extensions positioned towards a location of the field-spreading plate positioned in the opening, wherein the extensions are configured to hold the field-spreading plate positioned in the opening a specified distance from edges of the opening.

8. The apparatus of claim 6, further comprising a primary bobbin shaped to provide spacing between turns of the primary winding and further comprising a secondary bobbin shaped to provide spacing between turns of the secondary winding.

9. The apparatus of claim 2, wherein edges of the field-spreading plates are rounded and wherein the electrically insulating potting material is positioned at least in gaps around the edges of the field-spreading plates.

10. The apparatus of claim 1 wherein the electrically insulating potting material is substantially free of voids.

11. The apparatus of claim 1, wherein the materials with the high magnetic permeability of the primary magnetic core assembly and the secondary magnetic core assembly comprise a ferrite.

12. The apparatus of claim 1, wherein a thickness of the divider in a direction between the primary magnetic core assembly and the secondary magnetic core assembly is sized to a breakdown voltage rating.

13. The apparatus of claim 1, wherein a connection of a primary circuit is electrically connected to the primary magnetic core assembly, the primary circuit connected to the primary winding wound around the primary magnetic core assembly and wherein a connection of a secondary circuit is electrically connected to the secondary magnetic core assembly, the secondary circuit connected to the secondary winding wound around the secondary magnetic core assembly.

14. A converter comprising:
a primary circuit comprising a primary winding, the primary circuit comprising input terminals;
a secondary circuit comprising a secondary winding, the secondary circuit comprising output terminals; and
a transformer comprising:
a primary magnetic core assembly proximate to the primary winding;
a secondary magnetic core assembly proximate to the secondary winding, the primary magnetic core assembly and the secondary magnetic core assembly comprised of materials with a high magnetic permeability;
a divider placed between the primary and secondary magnetic core assemblies, the divider comprising an electrically insulating material; and
an electrically insulating potting material surrounding each of the magnetic core assemblies in a vicinity of the divider.

15. The converter of claim 14, wherein the primary magnetic core assembly and the secondary magnetic core assembly each comprise a field-spreading plate positioned adjacent to the divider, each field-spreading plate comprising an area adjacent to the divider that is greater than an area of a cross section of the magnetic core assembly adjacent to the field-spreading plate.

16. The converter of claim 15, wherein the primary magnetic core assembly and the secondary magnetic core assembly each comprise at least one core section, each core section comprising at least two extension sections positioned in parallel and connected by at least one connection section, wherein each extension section comprises a first end distal to the connection section, wherein the first end of each core section is adjacent to a field-spreading plate in contact with the divider.

17. The converter of claim 14, further comprising, for each of the primary magnetic core assembly and the secondary magnetic core assembly, a field-spreading plate positioner, each field-spreading plate positioner shaped to hold each field-spreading plate in a position adjacent to the divider prior to placement of the electrically insulating potting material, wherein an opening for each field-spreading plate is sized to accommodate the electrically insulating potting material.

18. The converter of claim 17, wherein the opening for each field-spreading plate comprises extensions positioned towards a location of the field-spreading plate positioned in the opening, wherein the extensions are configured to hold the field-spreading plate positioned in the opening a specified distance from edges of the opening.

19. A transformer comprising:
a primary winding proximate to a primary magnetic core assembly;
a secondary winding proximate to a secondary magnetic core assembly, the primary magnetic core assembly and the secondary magnetic core assembly comprised of materials with a high magnetic permeability;
a divider placed between the primary and secondary magnetic core assemblies, the divider comprising an electrically insulating material; and
an electrically insulating potting material surrounding each of the magnetic core assemblies in a vicinity of the divider,
wherein the primary magnetic core assembly and the secondary magnetic core assembly each comprise a field-spreading plate positioned adjacent to the divider, each field-spreading plate comprising an area adjacent to the divider that is greater than an area of a cross section of the magnetic core assembly adjacent to the field-spreading plate,
wherein the primary magnetic core assembly and the secondary magnetic core assembly each comprise at least one core section, each core section comprising at least two extension sections positioned in parallel and connected by at least one connection section, wherein each extension section comprises a first end distal to the connection section, wherein the first end of each core section is adjacent to a field-spreading plate in contact with the divider, and wherein the at least one core section and field-spreading plates of the primary magnetic core assembly are in electrical connection with each other and the at least one core sections and field-spreading plates of the secondary magnetic core assembly are in electrical contact with each other.

20. The transformer of claim 19, further comprising, for each of the primary magnetic core assembly and the secondary magnetic core assembly, a field-spreading plate positioner, each field-spreading plate positioner shaped to hold each field-spreading plate in a position adjacent to the divider prior to placement of the electrically insulating potting material, wherein an opening for each field-spreading plate is sized to accommodate the electrically insulating potting material, wherein the opening for each field-spreading plate comprises extensions positioned towards a location of the field-spreading plate positioned in the opening, wherein the extensions are configured to hold the field-spreading plate positioned in the opening a specified distance from edges of the opening.
